(19) United States
(12) Patent Application Publication
(10) Pub. No.: US 2014/0032720 A1
(43) Pub. Date: Jan. 30, 2014

(54) Method for Sending Data to a Distant Server, Server, Computer-Readable Medium and Computer Program Related Thereto

(71) Applicants: Clément Moreau, Clamart (FR); Eric Carreel, Meudon (FR)

(72) Inventors: Clément Moreau, Clamart (FR); Eric Carreel, Meudon (FR)

(73) Assignee: Sculpteo, Vanves (FR)

(21) Appl. No.: 13/985,419

(22) PCT Filed: Mar. 1, 2011
(86) PCT No.: PCT/IB2011/000785

§ 371 Date: Aug. 14, 2013

(51) Int. Cl. H04L 29/08

(52) U.S. Cl. CPC H04L 67/10
USPC 709/219

(57) ABSTRACT

A method implemented at least in part by a computer for sending data to a distant server, the method comprising: (a) a sending step wherein a user sends data to the server in a non authenticated matter; (c) an authentication step wherein the origin of the data is authenticated by the server.

### FIELD OF THE INVENTION

This invention relates methods for sending data to distant servers, to servers, to computer-readable mediums and computer programs related thereto.

### BACKGROUND OF THE INVENTION

One example of such method is disclosed for instance in US2008/313287, wherein a user sends data—e.g. a picture—to a distant server by e-mail, using a specific e-mail address which identifies the user and more specifically one of the photo albums of the user which are stored in the server. Therefore, the user has to memorize a specific and complex e-mail address for each of his/her photo albums, which is not ergonomic.

One object of the present invention is to remedy this drawback.

### SUMMARY OF THE INVENTION

To this end, the invention proposes a method implemented at least in part by a computer for sending data to a distant server, the method comprising:

(a)a sending step wherein a user sends data to the server in a non authenticated manner;

(c)an authentication step wherein the origin of the data authenticated by the server.

Thus, the user may send data to the server in a very simple way and the authentication of the origin of the data may be carried out by the server in a more ergonomic manner than in the prior art.

It should be noted that the above phraseology does not imply that the user actually uses a computer to send data: he or she may use an computer per se or any other device including a microprocessor or similar (camera, smart phone or other electronic equipment).

In various embodiments of the method according to the invention, one or more of the following provisions may be used:

at said sending step (a), the user sends an initial e-mail to a publicly known e-mail address which is non-specific to the user, said initial e-mail including said data;

said publicly known e-mail address is unique;

the method further includes, between the sending step (a) and the authentication step (c):

(b) a response step wherein a response e-mail is automatically sent to a response address of the initial e-mail, said response e-mail containing a link to a website, said link being specific to said data sent at the sending step,

and at the authentication step (c), the user accesses said website through said link and the origin of the data is authenticated through said website;

at said authentication step (c), the origin of the data is automatically authenticated if said user accesses said website through a personal device already having an active session with said website;

at said authentication step (c), the origin of the data is authenticated by entering at least one password on said website;

said authentication step (c) begins with creating a user account if the user previously had no account;

for sending said data to a gallery which is specific to the user, at said sending step (a), said data is automatically stored in a memory which is non-specific to the user gallery, and said authentication step (c) is followed by:

(d) a storage step wherein said data is automatically stored in the user gallery;

said storage step (d) is followed by a transaction step wherein a transaction is proposed to the user, related to said electronic object;

said data includes at least one electronic object;

said electronic object is chosen in the group comprising: a photograph, a 3D model. Another object of the invention is a server programmed to perform actions comprising:

(a) receiving data on the server from a user in a non authenticated manner;

(c) authenticating the origin of the data.

Still another object of the present invention is a computer-readable medium having computer-executable instructions, which when executed on a server, perform actions comprising:

(a) receiving data on the server from a user in a non authenticated manner;

(c) authenticating the origin of the data.

A further object of the present invention is a computer program which when executed on a server, perform actions comprising:

(a) receiving data on the server from a user in a non authenticated manner;

(c) authenticating the origin of the data.

### BRIEF DESCRIPTION OF THE DRAWINGS

Further characteristics and advantages of the invention will become apparent on reading the following description of one embodiment thereof, given as non-limitative examples, in relation to the attached drawings.

On the drawings:

FIG. 1 illustrates an embodiment of a system for using a method of the invention,

FIG. 2 is a flowchart illustrating an embodiment of the method according to the invention.

### MORE DETAILED DESCRIPTION

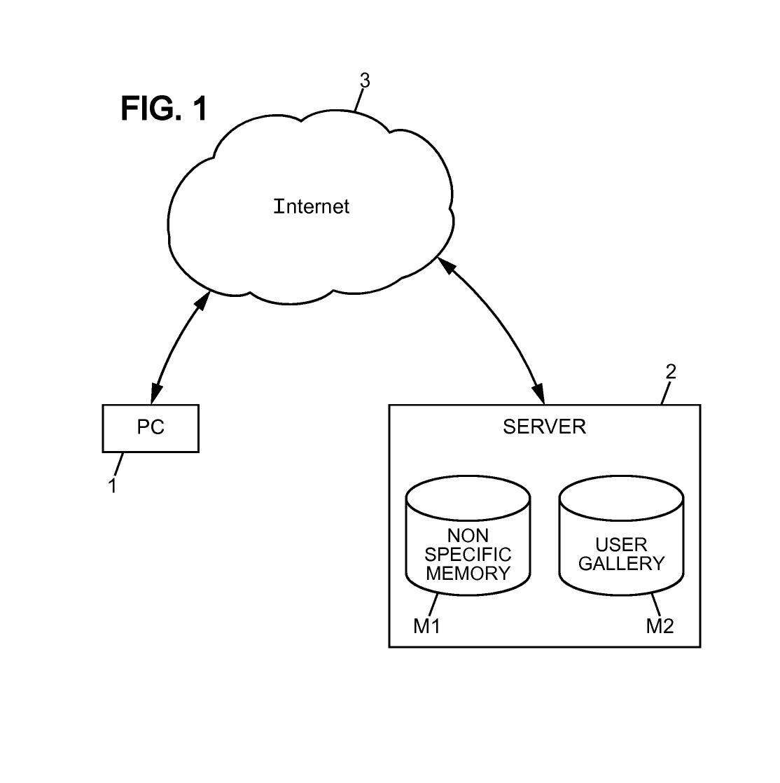

As illustrated in FIG. 1, the invention provides for a method for sending data form a user, and particularly from a user's computer 1 (PC) or other electronic device to a server 2 through the Internet 3 or other network. The server 2 may include a non specific memory M1 which is not specific to any user, in which data sent by the user's computer 1 is originally stored by the server 2. This non specific memory M1 can be simply a reception mailbox or similar of a messaging client which is present in the server 2.

The server 2 further includes at least one user gallery M2, which is a memory specific to one particular user.

It should be noted that the server 2 may include several physical servers and the memories Ml, M2 can be constituted by memory devices separate from any physical server.

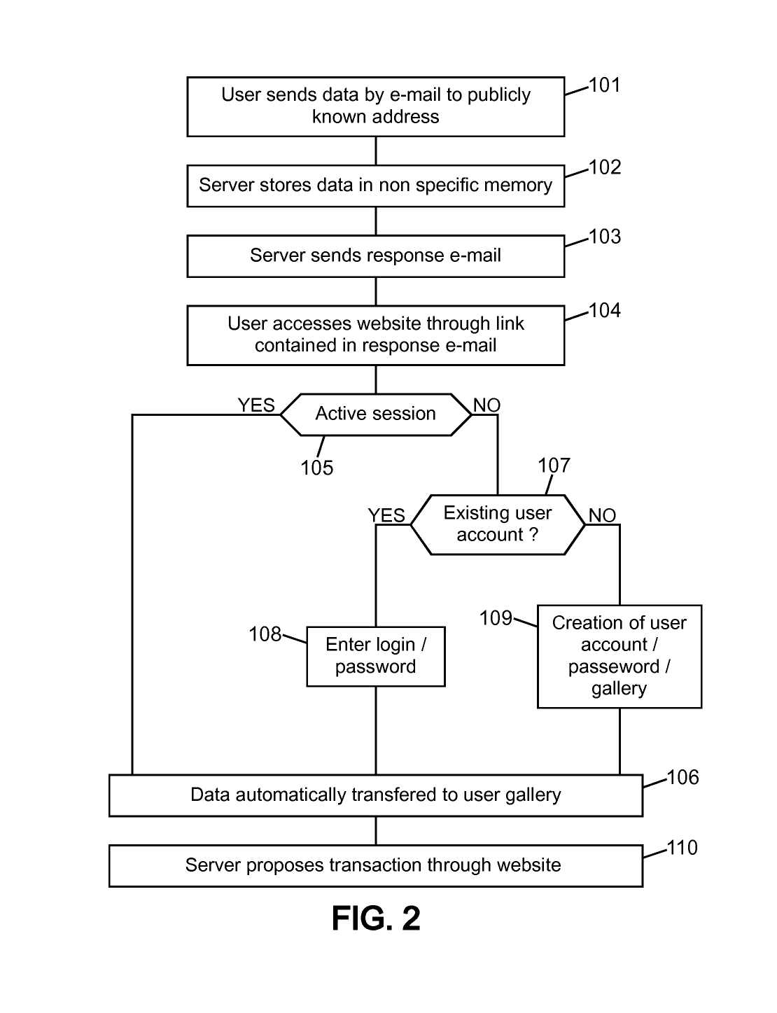

As illustrated by FIG. 2, in a particular embodiment of the present invention, the user may send data trough his computer 1 to the server 2 by email, to a publicly known address, at step 101. This publicly known address may be unique to the server or to the service provided by the server. For instance, supposing that the server provides a printing service for photos or 3D objects, and supposing that this service if entered through a website called for instance www.sculpteo.com, then this publicly known address may be simply sculpteo@sculpteo.com. In this example, the data sent to the server will include at least one electronic object such as at least one photo or at least one 3D model.

Then, at step 102, the server stores the received data in the non-specific memory Ml, for instance in a reception mailbox as indicated above, or in any other type of non specific memory.

Then at steps 103, the server sends a response email to the user, said response email including a link which is specific to the particular data sent at step 101. This link provides access to website, for instance www.sculpteo.com in the above example.

Then, at step 104, the user accesses the website through the link contained in the response email, simply by clicking on this link.

At step 105, the server determines whether the user's computer 1 still has an active session with the website. If the response is yes, then the user is thus automatically authenticated (or more generally speaking, the origin of the data is authenticated); therefore, data sent at step 101 and initially stored in the non specific memory M1, is automatically transferred to the user's gallery M2, at step 106. If the response of step 105 is no, then the server proposes the user a web page enabling to access to his account, or enabling to create an account if the user has not yet any account at step 107.

If the user has already an account, he simply enters for instance his login and password on the above web page at step 108, and once the user is thus authenticated (or more generally speaking, the origin of the data is authenticated), the data is automatically transferred to the user's gallery M2 at step 106.

If the user had no account yet, he may click on a particular button on the web page and thus obtain a new web page enabling to create his user account by giving the required information and creating for instance a login, a password and at least one gallery on the server, at step 109. At the end of this creation of the user's account, the user is thus authenticated (or more generally speaking, the origin of the data is authenticated) and the data sent at step 101 is automatically transferred to the user gallery at step 106.

After step 106, the server may, in some cases, propose a transaction to the user through the website. For instance, if the data sent to the server are constituted by one or several 3D models or several photos corresponding to a least one 3D object, the server may propose the user to “print” at least one plastic 3D object corresponding to the 3D models or the photos.

1. A method implemented at least in part by a computer for sending data to a distant server, the method comprising:
(a) a sending step wherein a user sends data to the server in a non authenticated manner;
(c) an authentication step wherein the origin of the data is authenticated by the server.

2. The method according to claim 1, wherein at said sending step (a), the user sends an initial e-mail to a publicly known e-mail address which is non-specific to the user, said initial e-mail including said data.

3. The method according to claim 2, wherein said publicly known e-mail address is unique.

4. The method according to claim 1, further including, between the sending step (a) and the authentication step (c):
(b) a response step wherein a response e-mail is automatically sent to a response address of the initial e-mail, said response e-mail containing a link to a website, said link being specific to said data sent at the sending step, and wherein at the authentication step (c), the user accesses said website through said link and the origin of the data is authenticated through said website.

5. The method as claimed in claim 4, wherein at said authentication step (c), the origin of the data is automatically authenticated if said user accesses said website through a personal device already having an active session with said website.

6. The method as claimed in claim 4, wherein at said authentication step (c), the origin of the data is authenticated by entering at least one password on said website.

7. The method as claimed in claim 4, wherein said authentication step (c) begins with creating a user account if the user previously had no account.

8. The method according to claim 1 for sending said data to a gallery which is specific to the user, wherein at said sending step (a), said data is automatically stored in a memory which is non-specific to the user gallery, and wherein said authentication step (c) is followed by:
(d) a storage step wherein said data is automatically stored in the user gallery.

9. The method as claimed in claim 8, wherein said storage step (d) is followed by a transaction step wherein a transaction is proposed to the user, related to said electronic object.

10. The method as claimed in claim 1, wherein said data includes at least one electronic object.

11. The method according to claim 10, wherein said electronic object is chosen in the group comprising: a photograph, a 3D model.

12. A server programmed to perform actions comprising:
(a) receiving data on the server from a user in a non authenticated manner;
(c) authenticating the origin of the data.

13. A computer-readable medium having computer-executable instructions, which when executed on a server, perform actions comprising:
(a) receiving data on the server from a user in a non authenticated manner;
(c) authenticating the origin of the data.

14. The computer program which when executed on a server, perform actions comprising:
(a) receiving data on the server from a user in a non authenticated manner;
(c) authenticating the origin of the data.
